(19) United States
(12) Patent Application Publication
(10) Pub. No.: US 2003/0201946 A1
(43) Pub. Date: Oct. 30, 2003

(54) Antenna with enclosed receptors

(76) Inventor: Hui-Ying Sheen, Torrance, CA (US)

Correspondence Address: SHELDON & MAK, Suite 900, 225 South Lake Avenue, Pasadena, CA, 91101, US

(21) Appl. No.: 10/136,761

(22) Filed: Apr. 30, 2002

(51) Int. Cl. H01Q 1/42

(52) U.S. Cl. 343/872

(57) ABSTRACT

An antenna component combination has an array of metallic antenna receptors which are surrounded by a flexible waterproof bag. In one embodiment, the waterproof bag is a plastic bag having a forward wall and a rearward wall, and the array of antenna receptors is physically attached to the rearward wall of the waterproof bag. In another embodiment, the array of antenna receptors is attached to a flexible backing sheet. The antenna component combination can be fashioned into a working antenna by attachment of a metallic radio frequency reflective shield either to the outside of the rearward plastic bag wall or, in embodiments using a flexible backing sheet, to the back side of the backing sheet opposite the side of the backing sheet to which the antenna receptors are attached.

### FIELD OF THE INVENTION

This invention relates generally to antennas and, more specifically, to microstrip antennas having a plurality of antenna receptor/radiators.

### BACKGROUND OF THE INVENTION

Microstrip antennas having a plurality of antenna receptor/radiators are commonly used in a wide variety of applications, such as in receiving internet transmissions from a wireless internet service provider. A typical microstrip antenna is disclosed in U.S. Pat. No. 4,914,445, the entirety of which is incorporated by this reference. A method for making a microstrip antenna is disclosed in U.S. Pat. No. 5,829,121 the entirety of which is also incorporated herein by this reference.

A problem with microstrip antennas of the prior art is that they tend to be bulky, fragile and/or rigid. Each of these characteristics make it difficult and expensive to manufacture, ship and install the antennas.

Another problem with microstrip antennas of the prior art is that they tend to be very sensitive to moisture. Even a small amount of moisture on the antenna receptors can render the antenna unreliable or even inoperable.

Accordingly, there is a need for a microstrip antenna which avoids these problems in the prior art.

### SUMMARY OF THE INVENTION

The invention satisfies this need. The invention is an antenna component combination comprising (a) an array of metallic antenna receptors disposed in an antenna receptor plane and (b) a flexible waterproof bag completely surrounding the antenna receptors.

The antenna receptors can be physically attached to the waterproof bag or they can be attached to a flexible backing sheet.

In all cases, the antenna component combination is lightweight, durable and flexible. The antenna component combination can be easily and inexpensively shipped because of its lightweight, durability and flexible nature. Because of its flexible nature, the antenna component is easily assembled onto an antenna support having a curved surface.

### DESCRIPTION OF THE DRAWINGS

These and other features, aspects and advantages of the present invention will become better understood with reference to the following description, appended claims and accompanying drawings where:

FIG. 1 is a diagrammatic cross-sectional detail view of a first embodiment of the invention having features of the invention;

FIG. 2 is a diagrammatic cross-sectional detail view of a second embodiment of the invention;

FIG. 3 is a diagrammatic cross-sectional detail view of a third embodiment of the invention;

FIG. 4 is a planar view of an integrated antenna combination having features of the invention;

FIG. 5 is a cross-sectional end view of the combination illustrated in FIG. 4;

FIG. 6 is a cross-sectional side view of the combination illustrated in FIG. 4;.

FIG. 7 is a planar view of a backing plate useable in the combination illustrated in FIG. 4.

FIG. 8 is a cross-sectional end view of the backing plate illustrated in FIG. 7; and

FIG. 9 is a cross-sectional side view of the backing plate illustrated in FIG. 7.

### DETAILED DESCRIPTION

The following discussion describes in detail one embodiment of the invention and several variations of that embodiment. This discussion should not be construed, however, as limiting the invention to those particular embodiments. Practitioners skilled in the art will recognize numerous other embodiments as well.

The invention is an antenna component combination 10 comprising an array of metallic antenna receptor/radiators (“antenna receptors 12”) and a flexible waterproof bag 14 completely surrounding the antenna receptors 12.

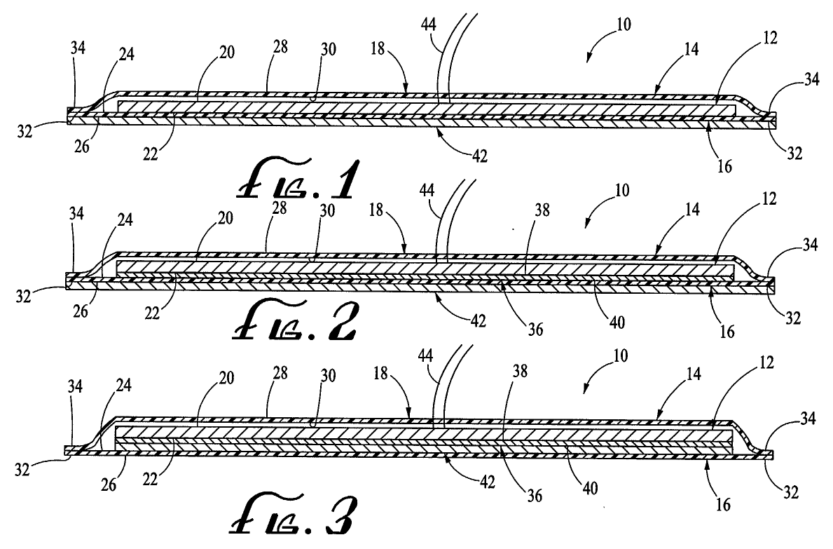

FIG. 1 illustrates a first embodiment of the invention in diagrammatic form. As can be seen from FIG. 1 the array of antenna receptors 12 is disposed between a first flexible plastic sheet 16 and a second flexible plastic sheet 18. The array of antenna receptors 12 are initially disposed in an antenna receptor plane. The antenna receptors 12 have a front side 20 and a back side 22.

The first plastic sheet 16 has a front side 24 and a back side 26, and the second plastic sheet 18 has a front side 28 and a back side 30. As can be seen in FIG. 1, the back side 22 of the antenna receptors 12 is disposed on the front side 24 of the first plastic sheet 16 and the back side 30 of the second plastic sheet 18 is disposed over the front side 20 of the antenna receptors 12. In a typical embodiment, the antenna receptors 12 are adhered to the first plastic sheet 16 by an adhesive, such as OPE.

Typically, the thickness of both the first plastic sheet 16 and the second plastic sheet 18 is between about 0.05 mm and about 0.15 mm, most typically between about 0.05 mm and about 0.10 mm. In one embodiment, both the first plastic sheet 16 and the second plastic sheet 18 has a thickness of about 0.08 mm and is a composite of a 0.05 mm sheet of polyethylene terephthalate, OPE adhesive and a 0.015 mm thickness sheet of ethylene vinyl acetate.

In the embodiment illustrated in FIG. 1, the antenna receptors 12 are typically attached at least to the front side 24 of the first plastic sheet 16 by adhesives or other suitable means. The antenna receptors 12 can also be laminated to both the first plastic sheet 16 and the second plastic sheet 18.

In a typical embodiment, the first plastic sheet 16 has approximately the same size and dimensions as the second plastic sheet 18 so that the outside perimeter 32 of the first plastic sheet 16 can be placed into a abutment with the outside perimeter 34 of the second plastic sheet 18. Thereafter, the outside perimeter 32 of the first plastic sheet 16 is sealed by heat, adhesives or other sealing methods to the outside perimeter 32 of the second plastic sheet 18 so as to form a waterproof bag 14 which wholly surrounds the antenna receptors 12.

The array of antenna receptors 12 is typically made from a metal having a very high electrical conductivity. Copper and copper alloys are the most typical materials used in the antenna receptors 12. The antenna receptors 12 can be formed by a wide variety of suitable methods, including cutting, etching and stamping. In one embodiment, the thickness of the antenna receptors 12 is about 0.5 mm.

To use the antenna component combination in the assembly of microstrip antenna, a metallic radio frequency reflective shield 42 is disposed proximal to the back side 22 of the antenna receptors 12. In a typical embodiment, the reflective shield 42 is made from an aluminum or an aluminum alloy.

As illustrated in FIG. 1, the reflective shield 42 is typically attached to the back side 26 of the first plastic sheet 16, such as by the use of adhesives or other suitable attachment means.

FIG. 2 is a diagrammatic view of a second embodiment of the invention. In this embodiment of the invention, the array of antenna receptors 12 is disposed onto a flexible backing sheet 36 having a front side 38 and a back side 40. The flexible backing sheet 36 can be made from a wide variety of light weight, flexible materials, such as from plastic or from a plastic foam material. In one typical embodiment, the backing sheet 36 is made from a plastic foam material having a thickness of about 0.7 mm.

The back side 22 of the antenna receptors 12 is physically attached to the front side of the backing sheet 36 by adhesives or other suitable attachment means. The combination of the antenna receptors 12 and the backing sheet 36 is fully enclosed within a waterproof bag 14, such as described above with respect to the embodiment illustrated in FIG. 1.

In the embodiment illustrated in FIG. 2, the reflective shield 42 is attached to the back side 30 of the second plastic sheet 18, such as by the use of adhesives or other suitable attachment means.

FIG. 3 illustrates a third embodiment of the invention. This embodiment is similar to the embodiment illustrated in FIG. 2 except that the reflective shield 42 is wholly disposed within the waterproof bag 14. In this embodiment, the reflective shield 42 is attached directly to the back side 40 of the backing sheet 36, such as by the use of adhesives or other suitable attachment means.

In all embodiments, the array of antenna receptors 12 is attached to signal receiving equipment (not shown) disposed apart from the antenna component combination 10, typically by a length of coaxial cable 44 soldered to the antenna receptors 12 and running across the web of one of the plastic sheets 16 or 18 to the reception equipment. The cable 44 is sealed to the plastic sheet 16 or 18 at the location where the cable 44 passes through the plastic sheet 16 or 18.

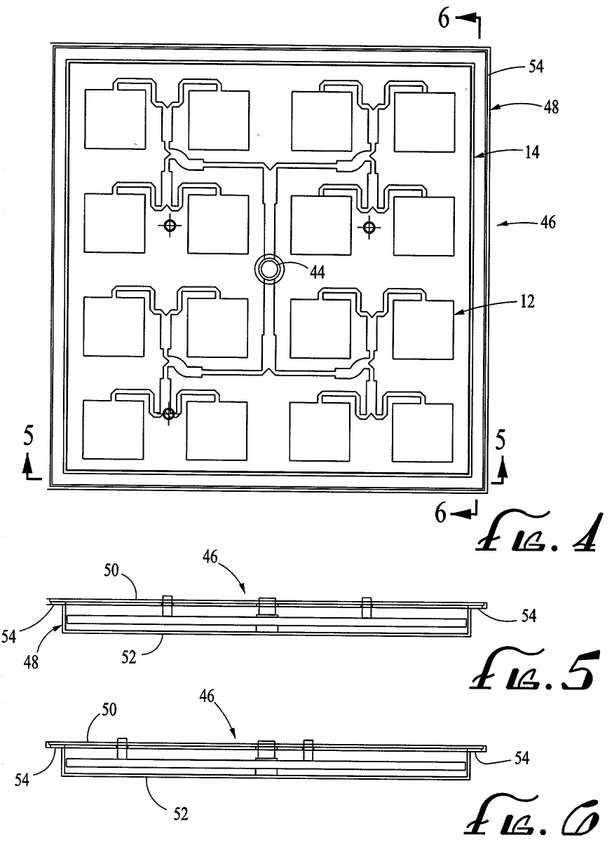

FIGS. 4-9 illustrate the antenna component combination 10 as a component of an integrated antenna 46. In the embodiment illustrated in FIGS. 4-9, the antenna component combination 10 is disposed within an antenna housing 48. The antenna housing 48 is typically made from a plastic material but has a metallic housing cover 50. As illustrated in FIGS. 2 and 3, the antenna component combination 10 is disposed within the antenna housing 48 such that the front side 20 of the antenna receptors 12 is disposed towards the plastic bottom wall 52 of the housing 48. The metallic housing cover 50 is disposed within a peripheral lip 54 at the top of the antenna housing 48.

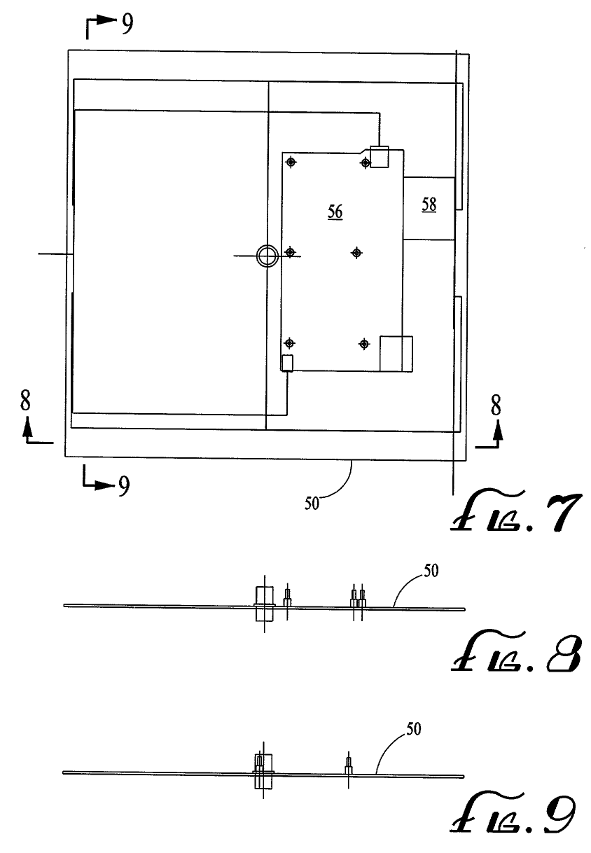

As illustrated in FIG. 7, the antenna housing 48 can further comprise a computer board 56 and a radio transmitter 58. Both the computer board 56 and the radio transmitter 58 can be operably attached to the antenna receptors 12 via the cable 44. The computer board 56 is used to accept data obtained via the antenna receptors 12. Where the antenna 46 is used to receive internet data from a wireless internet service provider, the computer board 56 can be used to review and confirm the integrity of the received data. To the extent that the received data is perceived by the computer board 56 to be defective, the radio transmitter 58 can be used to signal the internet service provider to resend the data. In the embodiment illustrated in FIGS. 4-9, the computer board 56 and the radio transmitter 58 are disposed between the antenna component combination 10 and the antenna housing cover 50.

The antenna component combination of the invention is both light weight and durable. This allows the antenna component combination to be easily and inexpensively shipped. Moreover, the antenna component combination is flexible which can be advantageous in shipment and in storage. More importantly, the flexibility of the antenna component combination allows the antenna component combination to be appended to an antenna support having a curved surface. The fact that the antenna component combination is disposed within a flexible bag tends to make the antenna component combination “waterproof.” This is a marked advantage over antenna components of the prior art which are highly susceptible to malfunction due to moisture contact with the metallic antenna receptors.

Having thus described the invention, it should be apparent that numerous structural modifications and adaptations may be resorted to without departing from the scope and fair meaning of the instant invention as set forth hereinabove and as described herein below by the claims.

What is claimed is:

1. An antenna component combination comprising:
(a) an array of metallic antenna receptors disposed in an antenna receptor plane, the antenna receptors having a front side and a backside; and
(b) a flexible waterproof bag completely surrounding the antenna receptors.

2. The antenna component combination of claim 1 further comprising a flexible backing sheet having a front side and a backside, the backside of the antenna receptors being disposed in abutment with the front side of the backing sheet.

3. The antenna component combination of claim 2 wherein the backing sheet is made of a plastic material.

4. The antenna component combination of claim 2 wherein the backing sheet is made of a foamed plastic material.

5. The antenna component combination of claim 1 further comprising a metallic radio frequency reflective shield disposed proximal to the back side of the antenna receptors.

6. The antenna component combination of claim 5 wherein the reflective shield is made of an aluminum alloy.

7. The antenna component combination of claim 1 wherein the waterproof bag is made of a plastic material.

8. The antenna component combination of claim 1 wherein the waterproof bag comprises polyethylene terephthalate and ethylene vinyl acetate.

9. The antenna component combination of claim 1 wherein the waterproof bag is made of a plastic material having a thickness between about 0.05 mm and about 0.15 mm.

10. The antenna component combination of claim 2 wherein the antenna component combination is disposed within an antenna housing.

11. The antenna component combination of claim 10 wherein the antenna housing is made of a plastic material but has a metallic housing cover.

12. The antenna component combination of claim 11 wherein a computer for processing data received by the antenna is disposed within the antenna housing between the reflective shield and the housing cover.

13. The antenna component combination of claim 11 further comprising a radio transmitter for transmitting radio signals via the antenna, the radio transmitter being disposed between the reflective shield and the housing cover.

14. An antenna comprising:
(a) a flexible foamed plastic backing sheet having a front side and a back side;
(b) an array of metallic antenna receptors disposed on the front side of the backing sheet;
(c) a flexible waterproof plastic bag completely surrounding the backing sheet; and
(d) a metallic radio frequency reflective shield disposed proximal to the back side of the backing sheet, the reflective shield being made of an aluminum alloy.

15. The antenna of claim 14 wherein the antenna is disposed within an antenna housing.

16. The antenna of claim 15 wherein the antenna housing is made of a plastic material but has a metallic housing cover.

17. The antenna of claim 16 wherein a computer for processing data received by the antenna is disposed within the antenna housing between the reflective shield and the housing cover.

18. The antenna of claim 16 further comprising a radio transmitter for transmitting radio signals via the antenna, the radio transmitter being disposed between the reflective shield and the housing cover.

19. The antenna of claim 16 further comprising (i) a computer for processing data received by the antenna is disposed within the antenna housing between the reflective shield and the housing cover, and (ii) a radio transmitter for transmitting radio signals via the antenna, the radio transmitter being disposed between the reflective shield and the housing cover.

20. An antenna component combination comprising:
(a) a first flexible plastic sheet having a front side and a backside;
(b) an array of metallic antenna receptors disposed in an antenna receptor plane, the antenna receptors having a front side and a backside, the backside of the antenna receptors being disposed on the front side of the first plastic sheet; and
(c) a second flexible plastic sheet housing a front side and a back side, the back side of the second plastic sheet is disposed over the front side of the antenna receptors, the first plastic sheet being sealed to the second plastic sheet such that the first plastic sheet and the second plastic sheet form a waterproof bag which wholly surrounds the antenna receptors.
